(19) United States
(12) Patent Application Publication
(10) Pub. No.: US 2021/0138614 A1
(43) Pub. Date: May 13, 2021

(54) WATER CLOSET CARRIER INSTALLATION TOOL KIT

(71) Applicant: Steven Giehl, Grove City, OH (US)

(72) Inventor: Steven Giehl, Grove City, OH (US)

(21) Appl. No.: 16/681,395

(22) Filed: Nov. 12, 2019

(51) Int. Cl. B25B 13/06; B25B 23/00

(52) U.S. Cl. CPC B25B 13/06; B25B 23/0035

(57) ABSTRACT

An illustrated side view of an exemplary water-closet horn socket device for removing a water-closet horn from a water closet carrier faceplate for access to a water-closet carrier is presented. The water-closet horn socket device is useful for providing a safe and efficient method for removing the water-closet horn coupled to the water-closet carrier faceplate protecting the water-closet carrier. The water-closet horn socket device further is useful for providing removal of the water-closet horn by being a longer socket device such that access to the horn is easier and more efficient.

### FIELD OF THE INVENTION

This invention relates to water closet carriers. More particularly, it relates a device to install, assemble and disassemble a water closet carrier including the horn.

### BACKGROUND

The term “water closet” (“WC”) was an early term for an interior or exterior room with a flushing toilet in contrast with an earth closet usually outdoors and requiring periodic emptying as “night soil”. Originally, the term “wash-down closet” was used. The term “water closet” was coined in England around 1870. It did not reach the United States until the 1880s. Around this time, only luxury hotels and wealthy people had indoor private bathrooms. By 1890 in the US, there was increased public awareness of the theory of disease and of carelessly disposed human waste being contaminated and infectious.

Plumbing is any system that conveys fluids for a wide range of applications. Plumbing uses pipes, valves, plumbing fixtures, tanks, and other apparatuses to convey fluids. Heating and cooling (HVAC), waste removal, and potable water delivery are among the most common uses for plumbing, but it is not limited to these applications.

In the developed world, plumbing infrastructure is critical to public health and sanitation.

Boilermakers and pipefitters are not plumbers although they work with piping as part of their trade and their work can include some plumbing.

Plumbing equipment includes devices often behind walls or in utility spaces which are not seen by the general public. It includes water meters, pumps, expansion tanks, back flow preventers, water filters, UV sterilization lights, water softeners, water heaters, heat exchangers, gauges, and control systems.

There are many tools a plumber needs to do a good plumbing job. While many simple plumbing tasks can be completed with a few common hand held tools, other more complex jobs require specialized tools, designed specifically to make the job easier.

Specialized plumbing tools include pipe wrenches, flaring pliers, pipe vise, pipe bending machine, pipe cutter, dies, and joining tools such as soldering torches and crimp tools. New tools have been developed to help plumbers fix problems more efficiently. For example, plumbers use video cameras for inspections of hidden leaks or other problems; they also use hydro jets, and high-pressure hydraulic pumps connected to steel cables for trench-less sewer line replacement.

Flooding from excessive rain or clogged sewers may require specialized equipment, such as a heavy-duty pumper truck designed to vacuum raw sewage.

The carrier for the water to get to the water closet are set inside of the walls. The carrier has a socket faceplate that protects the carrier from damage that may occur to the water such as a nail or screw being used to couple an object to the outside of the wall and allows the carrier to pitch for the proper drainage while keeping all fixtures at the same elevation. When accessing the carrier, it is often difficult to remove the socket faceplate to attain access to the carrier. Current tools are often too short or have different sizes that cannot fit the nuts bolting the socket faceplate in place.

In light of the foregoing, there is a need for a device to provide a safe, efficient and effective method to remove the socket faceplate when access is necessary to resolve a plumbing issue in the carrier.

### BRIEF DESCRIPTION OF THE DRAWINGS

FIG. 1 is an illustrated view of an exemplary horn socket and horn socket coupler of an exemplary water-closet carrier installation tool kit.

FIG. 2 is an illustrated a view of an exemplary bolt socket and socket coupler of the water-closet carrier installation tool kit shown in FIG. 1.

FIG. 3 is an illustrated view of a water closet carrier rod socket of the water-closet carrier installation tool kit shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Referring to FIG. 1, an illustrated side view of an exemplary water-closet horn socket device 100 for removing a water-closet horn from a water closet carrier faceplate for access to a water-closet carrier is presented. The water-closet horn socket device 100 is useful for providing a safe and efficient method for removing the water-closet horn coupled to the water-closet carrier faceplate protecting the water-closet carrier. The water-closet horn socket device 100 further is useful for providing removal of the water-closet horn by being a longer socket device 100 such that access to the horn is easier and more efficient.

The water-closet horn socket device 100 has a socket coupler 200 and a horn coupler 300. The socket coupler 200 is preferably made of an impact grade material, however other materials are hereby contemplated, including, but not limited to, steel, aluminum, poly-vinyl chloride (PVC), etc. The socket coupler 200 preferably has a length of two (2) inches, however other lengths are hereby contemplated, including, but not limited to, one and one-half (1.5) inches, two and one-half (2.5) inches, etc. The socket coupler 200 preferably has a hexagonal shape, however other shapes are hereby contemplated, including, but not limited to, round, octagonal, square, etc. The socket coupler 200 preferably is a diameter of fifteen-sixteenths ( 15/16) inch. The diameter of the socket coupler 200 is configured to fit a fifteen-sixteenths ( 15/16) inch socket.

The socket coupler 200 has a plurality of sides 201, a first end 202 and a second end 203. A spring 204 is coupled to one of the plurality of sides 201. The spring 204 is further coupled to a machined groove 205 of a first of the plurality of sides 201 of the socket coupler 200. The spring 204 is preferably a thin bow spring, however other springs are hereby contemplated, including, but not limited to, helical spring, linear rate spring, progressive rate spring, etc.

The first end 201 has a socket connector 205. The socket connector 205 is a female coupling end. The socket connector 205 is preferably square in shape. The socket connector 205 is preferably couplable to a one-half (0.5) inch socket drive.

The horn coupler 300 preferably has a width of one-half (0.5) inch, however other widths are hereby contemplated, including, but not limited to, one-fourth (0.25) inch, three-fourth (0.75) inch, etc. The horn coupler 300 preferably has a depth of one-half (0.5) inch, however other depths are hereby contemplated, including, but not limited to, one-fourth (0.25) inch, three-fourth (0.75) inch, etc. The horn coupler 300 preferably is a length for a three (3) inch or four (4) inch horn. The horn coupler 300 preferably has a rectangular shape.

The horn coupler 300 has a first side 301, a second side 302, a first end 303 and a screw 304. A middle 305 of the first side 301 is coupled to the second end 203 of the socket coupler 200.

The screw 304 is coupled to the first end 303 of the horn coupler 300. The first end 303 of the horn coupler 300 being threaded to receive the screw 304. The screw 304 is adjustable determined by a centering on the socket coupler 200. The screw is preferably a square head screw.

The water-closet horn socket device 100 is to be used with an existing water closet horn 400. The horn coupler 300 is adjustable to either three (3) to three and one-half (3.5) inches or four (4) to four and one-half (4.5) inches by the screw 304.

Moving now to FIG. 2, an illustrated a view of an exemplary water-closet bolt socket device 600 for installing or removing bolts from a water-closet carrier faceplate and corner legs is presented. The water-closet bolt socket device 600 is useful for providing a safe and efficient method for removing the water-closet faceplate coupled to the water-closet carrier. The water-closet bolt socket device 600 further is useful for providing removal of the water-closet bolt by being a longer socket device 600 such that access to the bolts is easier and more efficient.

The water-closet bolt socket head 600 has a bolt socket 700 and socket coupler 800.

The socket head 600 is preferably made of an impact grade material, however other materials are hereby contemplated, including, but not limited to, steel, aluminum, poly-vinyl chloride (PVC), etc. The socket coupler 600 preferably has a length of two (2) inches, however other lengths are hereby contemplated, including, but not limited to, one and one-half (1.5) inches, two and one-half (2.5) inches, etc. The socket coupler 800 preferably has a hexagonal shape, however other shapes are hereby contemplated, including, but not limited to, round, octagonal, square, etc. The socket coupler 800 preferably is a diameter of fifteen-sixteenths ( 15/16) inch. The diameter of the socket coupler 800 is configured to fit a fifteen-sixteenths ( 15/16) inch socket.

The socket coupler 800 has a plurality of sides 801, a first end 802 and a second end 803. A spring 804 is configured to be coupled into a machine-groove 807 of one of the plurality of sides 801. The spring 804 is preferably a thin bow spring, however other springs are hereby contemplated, including, but not limited to, helical spring, linear rate spring, progressive rate spring, etc.

The first end 801 has a socket connector 805. The socket connector 805 is a female coupling end. The socket connector 805 is preferably square in shape. The socket connector 805 is preferably couplable to a one-half (0.5) inch socket drive.

The bolt socket 700 is preferably a round shape. The bolt socket 700 has a first end 701, a second end 702 and a socket opening 703.

The first end 701 of the bold socket 700 is coupled to the second end 802 of the socket coupler 800 by a retainer 806. The retainer 806 is preferably a one-half (0.5) inch flat washer. The socket coupler 800 is therefore designed to be used independently with a one-half (0.5) inch drive racket utilizing the socket connector 805 or by coupling to a carrier rod socket 900. The retainer 806 prevents the device 600 from sliding completely into the carrier rod socket.

The socket opening 703 of the bolt socket 700 is configured to be at the second end 702 of the bolt socket 700. The socket opening 703 is preferably hollow. The socket opening 703 is a hexagonal shape, such that the bolt socket 700 can removably couple to a bolt on the water-closet carrier socket faceplate without slippage. The socket opening 703 of the socket opening 703 is preferably three-fourths (¾) inch.

Referring now to FIG. 3, an illustrated view of a water closet carrier rod socket 900 of the water-closet horn socket device 100 shown in FIG. 1.

The water closet rod socket 900 is preferably made of an industrial grade material. The water closet rod socket 900 is preferably cylindrical. The water closet rod socket 900 is purposed to slide over rods that couple a water closet to a carrier. Thus, allowing easier access to nuts that secure the rods of the water closet carrier faceplate.

The water closet rod socket 900 has a first end 901, a second end 902 and a side 903.

The first end 901 of the water closet rod socket 900 has a socket connector 904. The socket connector 904 is preferably a square shape. The socket connector 904 is preferably one-half (0.5) inch such that the socket connector 900 is couplable to a one-half (0.5) inch socket drive 951 of a socket wrench 950.

The side 903 is preferably fifteen (15) inches in length.

The socket end 902 is preferably round in shape. The socket end 902 has an opening 905. The opening 905 of the socket end 902 is preferably a hexagonal shape configured to be a fifteen-sixteenth ( 15/16) inch socket. The socket end 902 is preferably hollow such that it retains the hexagonal shape. The socket end 902 is preferably hollow for a length of at least fourteen and one-fourth (14.25) inches.

The socket coupler 200 and the socket coupler 800 are designed to couple to the carrier rod socket 900 by being inserted into the opening 905.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A water-closet carrier installation kit for removing or installing a horn in a water-closet carrier, the kit comprising:
a socket coupler, the socket coupler having a plurality of sides, a first end and a second end;
a spring, the spring being coupled to a machined groove on one of the plurality of sides of the socket coupler;
a socket connector, the socket connector being coupled to the first end of the socket coupler;
a horn coupler, the horn coupler having a first side, a second side, a first end and a screw, wherein the screw being removably coupled to the first side of the horn coupler, and wherein the first side of the horn coupler being coupled to the second end of the socket coupler; and
a water-closet horn, the water closet horn having a first end and a plurality of notches, wherein the plurality of notches being coupled to the first end of the water-closet horn, and wherein the screw of the second end of the horn coupler being removably and adjustably coupled to one of the notches of the water-closet horn.

2. The kit of claim 1, wherein the kit being made of an impact grade material.

3. The kit of claim 1, wherein the socket coupler having a length being two (2) inches.

4. The kit of claim 1, wherein the socket coupler being a hexagonal shape.

5. The kit of claim 1, wherein the socket coupler diameter being fifteen-sixteenths ( 15/16) inch.

6. The kit of claim 1, wherein the spring being a thin bow spring.

7. The kit of claim 1, wherein the socket connector being couplable to a one-fourth (¼) inch socket drive.

8. The kit of claim 1, wherein the horn coupler having a length being one of: three (3) inches and four (4) inches.

9. The kit of claim 1, wherein the horn coupler being rectangular in shape.

10. A water-closet carrier installation kit for removing and installing bolts of a water-closet carrier faceplate and legs, the kit comprising:
a socket coupler, the socket coupler having a plurality of sides, a first end and a second end;
a spring, the spring being coupled to one of the plurality of sides of the socket coupler;
a socket connector, the socket connector being coupled to the first end of the socket coupler; and
a bolt socket, the bolt socket having a first end, a second end and a socket opening, wherein the second end having a socket opening, and wherein the first end of the bolt socket being coupled to the second end of the socket coupler by a coupler.

11. The kit of claim 10, wherein the kit being made of an impact grade material.

12. The kit of claim 10, wherein the socket coupler having a length being two (2) inches.

13. The kit of claim 10, wherein the socket coupler being a hexagonal shape.

14. The kit of claim 10, wherein the socket coupler diameter being fifteen-sixteenths ( 15/16) inch.

15. The kit of claim 10, wherein the spring being a thin bow spring.

16. The kit of claim 10, wherein the socket opening having a hexagonal shape.

17. The kit of claim 10, wherein the socket connector being a square shape.

18. The kit of claim 10, wherein the socket coupler being a female coupling end.

19. The kit of claim 10, wherein the bolt socket being a round shape.

20. The kit of claim 10, wherein the coupler being a one-half (0.5) inch flat washer.
